(19) United States
(12) Patent Application Publication
(10) Pub. No.: US 2007/0294460 A1
(43) Pub. Date: Dec. 20, 2007

(54) COMPUTER SYSTEMS AND MULTI-LATER USB I/O SYSTEMS THEREOF

(75) Inventor: Chao-Sheng Huang, Taipei (TW)

Correspondence Address: THOMAS, KAYDEN, HORSTEMEYER & RISLEY, LLP, 600 GALLERIA PARKWAY, STE 1500, ATLANTA, GA, 30339, US

(73) Assignee: VIA TECHNOLOGIES, INC., Taipei (TW)

(21) Appl. No.: 11/610,607

(22) Filed: Dec. 14, 2006

(30) Foreign Application Priority Data
Jun. 16, 2006 (TW) 95121576

(51) Int. Cl. G06F 13/36; G06F 13/00

(52) U.S. Cl. 710/315; 710/300

(57) ABSTRACT

A multi-layer universal serial bus (USB) input/output (I/O) system comprising a chipset, at least one USB port, and an I/O port. The chipset controls data transmission. The I/O control chip is coupled between the system chipset and the USB port. The chipset controls data transmission of the USB port through the I/O control chip.

### BACKGROUND OF THE INVENTION

1. Field of the Invention

The invention relates to a computer system, and in particular to a computer system with a multi-layer USB input/output (I/O) system.

2. Description of the Related Art

Universal serial buses (USB) integrate various peripheral interfaces of a computer system, and peripheral devices of the computer system use the same interface, thus eliminating compatibility issues due to different interfaces. In the past, connecting peripheral devices, such as digital cameras, printers, displays, modems, keyboards, and mice, require complicated installation procedures. USB devices have the ability to plug and play, thus, installation procedures are greatly simplified. Current computer systems thus have built-in USB ports for connecting various peripheral devices of the computer systems.

### BRIEF SUMMARY OF THE INVENTION

The invention provides a multi-layer universal serial bus (USB) input/output (I/O) system includes a chipset, at least one USB port, and an I/O port. The chipset controls data transmission. The I/O control chip is coupled between the chipset and the USB port. The chipset controls data transmission of the USB port through the I/O control chip.

The invention also provides a computer system includes a central processing unit (CPU) processing the operations of the computer system. A chipset coupled to the CUP and controlling data transmission, at least one USB port; and an input/output (I/O) control chip coupled between the chipset and the USB port, wherein the chipset controls data transmission of the USB port through the I/O control chip.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 depicts a conventional computer system; and

FIG. 2 depicts an exemplary embodiment of a computer system.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

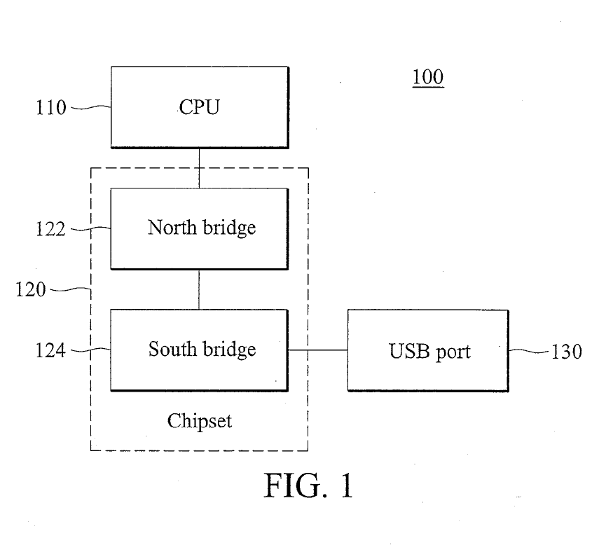

FIG. 1 is block diagram of a computer system 100. The computer system 100 includes a central processing unit (CPU) 110, a chipset 120, and a USB port 130. The chipset 120 includes a north bridge 122 and a south bridge 124. The north bridge 122 processes the communication and management between the CPU 110 and a display and between the CPU 110 and memory. The south bridge 124 manages the connections between peripheral devices, such as storage devices (floppy/hard disks, CD-ROMs, and CD burners) and network devices, and provides PCI interfaces to expand and connect more peripheral devices. The south bridge 124 is further coupled to the USB port 130. Almost all peripheral devices, such as printers, network devices, speakers, and audio devices, are managed by the south bridge 124 except for displays are managed by the north bridge 122. The communication between the south bridge 124 and the CPU 110 is through the north bridge 122 to the CPU 110.

In the configuration of the computer system 100 as shown in FIG. 1, USB ports are coupled to the south bridge 124. One USB port has a pair of transmission signals, and each USB port requires two pins of the south bridge chip. When 8 to 10 USB ports are built into the computer system 100, 16 to 20 pins of the south bridge 124 are required, thus the number of required pins of the south bridge 124 is increased.

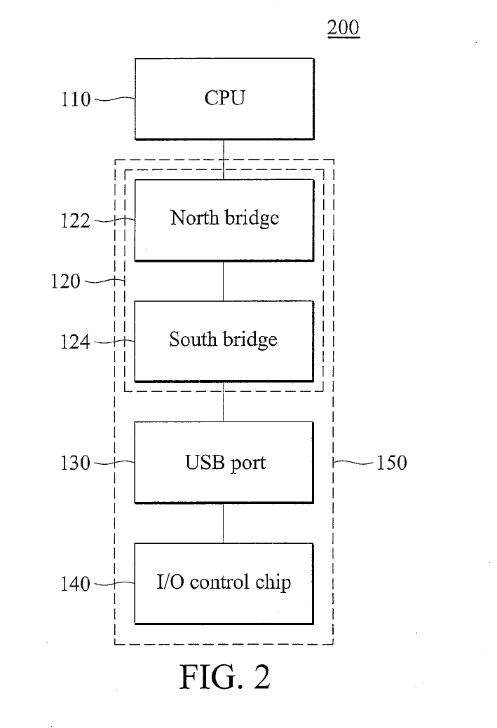

An exemplary embodiment of a computer system in the present invention is shown in FIG. 2 the computer system 200 includes a central processing unit (CPU) 110 and a multi-layer USB input/output (I/O) system 150. The multi-layer USB I/O system 150 includes a chipset 120, and at least one USB port 130 an I/O control chip 140. The chipset 120 includes a north bridge 122 and a south bridge 124. In FIG. 2, one USB port 130 is provided as an example. The computer system 200 is similar to the computer system 100 expect that I/O control chip 140 is coupled to the south bridge 124, and the USB port 130 is coupled to the I/O control chip 140 not to the south bridge 124. The elements of the computer system 200 in FIG. 2 same as those of the computer system 100 in FIG. 1 are identified with the same reference numerals, thus the functions of the same elements are not described here. In this embodiment, the I/O control chip 140 can be a super I/O chip, such as model VT-1211, for controlling various peripheral devices, such as floppy disks, keyboards, mouse ports, parallel/serial ports, and infrared ray ports. The USB port 130 is coupled to the south bridge 124 through the I/O control chip 140, and the south bridge 124 can thus control the data transmission of the UBS port 130. Because the transmission speed between the I/O control chip 140 and the south bridge 24 is higher than the transmission speed of the USB port 130, the number of pins of the south bridge 130 required for the USB port 130 is reduced. The USB port 130 of USB 2.0 is given as an example. The highest transmission speed of the USB port 130 is 480 Mbps. The highest transmission speed between the I/O control chip 140 and the south bridge 24 is (480*4) Mbps equal to four times the highest transmission speed of the USB port 130. Thus, for the same number of I/O ports, the number of pins of the south bridge 124 in the computer system 200 is one fourth of that of the south bridge 124 in the computer system 100. For example, when there are 16 build-in USB ports, 32(=16*2) pins of the south bridge 124 are required according to the configuration of the computer system 100, and 8(=(16*2)/4) pins of the south bridge 124 are required according to the configuration of the computer system 200. According to this embodiment, the number of pins of the south bridge 124, required for the built-in USB ports, is reduced, thus the area is decreased. Moreover, because the number of pins of the south bridge 124 is reduced, the interference between signals is lowered, and the signal integrity is enhanced.

Currently, some interfaces provided by a super I/O chip, such as floppy disk drives and parallel/serial ports, are not typically used. The I/O pins preset for the interfaces, such as floppy disk drives and parallel/serial ports, are replaced by the I/O pins of the USB port 130, thus extra pins are not required for the USB port 130. In this embodiment, the I/O control chip 140 of FIG. 2 is implemented by a super I/O chip, however, other types of I/O control chips can be used according to system requirements.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A multi-layer universal serial bus (USB) input/output (I/O) system, comprising:
a chipset controlling data transmission;
at least one USB port; and
an I/O control chip coupled between the chipset and the USB port, wherein the chipset controls data transmission of the USB port through the I/O control chip.

2. The multi-layer USB I/O system as claimed in claim 1, wherein the chipset comprises a south bridge chip coupled to the I/O control chip.

3. The multi-layer USB I/O system as claimed in claim 2, wherein the chipset further comprises a north bridge coupled to the south bridge chip.

4. The multi-layer USB I/O system as claimed in claim 1, wherein the I/O control chip is a super I/O chip.

5. The multi-layer USB I/O system as claimed in claim 1, wherein the transmission speed between the I/O control chip and the chipset is higher than the transmission speed of the USB port.

6. The multi-layer USB I/O system as claimed in claim 1, wherein the transmission speed between the I/O control chip and the chipset is four times the transmission speed of the USB port.

7. A computer system, comprising:
a central processing unit (CPU) processing the operations of the computer system;
a chipset coupled to the CUP and controlling data transmission;
at least one USB port; and
a input/output (I/O) control chip coupled between the chipset and the USB port, wherein the chipset controls data transmission of the USB port through the I/O control chip.

8. The computer system as claimed in claim 7, wherein the chipset comprises a south bridge chip coupled to the I/O control chip.

9. The computer system as claimed in claim 8, wherein the chipset further comprises a north bridge coupled between the CPU and the south bridge chip.

10. The computer system as claimed in claim 7, wherein the I/O control chip is a super I/O chip.

11. The computer system as claimed in claim 7, wherein the transmission speed between the I/O control chip and the chipset is higher than the transmission speed of the USB port.

12. The computer system as claimed in claim 7, wherein the transmission speed between the I/O control chip and the chipset is four times the transmission speed of the USB port.
